(19) United States
(12) Patent Application Publication
(10) Pub. No.: US 2026/0008259 A1
(43) Pub. Date: Jan. 8, 2026

(54) MANUAL COLD LAMINATING MACHINE

(71) Applicant: Haocai ZHENG, Dongguan City (CN)

(72) Inventor: Haocai ZHENG, Dongguan City (CN)

(73) Assignee: DONGGUAN JIAXI OFFICE MACHINE CO., LTD., Dongguan City (CN)

(21) Appl. No.: 19/325,551

(22) Filed: Sep. 11, 2025

(30) Foreign Application Priority Data
Aug. 14, 2025 (CN) 202511142082.8

(51) Int. Cl. B32B 37/00; B29C 63/02; B32B 37/10

(52) U.S. Cl. CPC B32B 37/0053; B29C 63/02; B32B 37/10; B32B 2037/0061

(57) ABSTRACT

A manual cold laminating machine includes a machine housing body, an upper housing assembly, a film roller assembly, a pressure roller assembly including a fixed pressure roller and a movable pressure roller, a transmission assembly, and a control handle. The transmission assembly automatically converts opening and closing motions of the upper housing assembly into displacement of the movable pressure roller via a transmission plate. The transmission plate is provided with an upper cover connecting groove having a locking groove portion and a curved groove portion for engaging with the upper housing assembly, and connects to the movable pressure roller via a pressure roller mounting groove; an elastic member provides preload force to ensure transmission stability. The film roller assembly employs sliding rail mounting for quick installation and removal, the upper housing assembly is provided with a press-type unlocking mechanism for default locked protection, and the foldable handle saves space.

### CROSS-REFERENCE TO RELATED APPLICATIONS

The application claims priority of Chinese patent application CN2025111420828, filed on Aug. 14, 2025, which is incorporated herein by reference in its entireties.

### TECHNICAL FIELD

The present disclosure relates to the technical field of laminating devices, and in particular, to a manual cold laminating machine for applying a cold laminating film to a surface of a sheet material.

### BACKGROUND OF THE INVENTION

In applications such as advertising graphic production and photographic output, where manual cold laminating machines are employed as critical equipment for applying cold laminating films to sheet materials such as posters and photographs, high-frequency batch operations are typically required. The laminating process essentially relies on achieving uniform and stable compression between the sheet material and cold laminating film through the pressure rollers. Nevertheless, conventional manual cold laminating machines exhibit significant operational and structural shortcomings: during material replacement or thickness adjustment, operators are compelled to execute two discrete operations—initially opening the upper housing assembly, followed by manually adjusting the spacing between the movable pressure roller and the fixed pressure roller. This disconnected operational steps proves not only laborious and time-intensive but also substantially diminishes operational efficiency, particularly in batch processing scenarios. Moreover, the manual adjustment mechanism fails to ensure precise bilateral pressure synchronization, frequently resulting in non-uniform compression that manifests as air bubbles or wrinkles, ultimately adversely affecting the quality of lamination.

Furthermore, existing devices face structural integration and stability challenges: inconvenient film roller replacement reduces film replacement efficiency; the rudimentary upper housing locking mechanism risks accidental opening or insecure closure; while separate edge-trimming functionality typically requires additional tools or operational steps. These issues not only directly compromise operational efficiency and yield rates, but the frequent adjustments and inherent device instability also increase operator fatigue, creating bottlenecks in enhancing manual laminating experience and productivity.

Therefore, the present disclosure provides a manual cold laminating machine with an innovative structure featuring a unique linkage transmission and integrated design that achieves unified “release-when-open and compress-when-close” operation while enhancing overall stability and functionality.

### SUMMARY OF THE INVENTION

In order to overcome the shortcomings of the prior art, the present disclosure provides a manual cold laminating machine featuring a simplified structure that effectively resolves reliable fixation issues in vibrational environments.

To solve its technical problem, the present disclosure adopts the following technical solution: A manual cold laminating machine includes a machine housing body and an upper housing assembly rotatably connected to it. A film roller assembly is detachably connected to the machine housing body. A pressure roller assembly is connected to the machine housing body and includes a fixed pressure roller and a movable pressure roller that is selectively movable toward or away from the fixed pressure roller. The machine also includes a transmission assembly. Specifically, when the upper housing assembly is opened, its rotational movement actuates the transmission assembly, thereby driving the movable pressure roller away from the fixed pressure roller. Conversely, when the upper housing assembly is closed, its rotational movement actuates the transmission assembly to drive the movable pressure roller toward the fixed pressure roller. A control handle is configured to control the manual cold laminating machine to apply a layer of cold laminating film onto a surface of a sheet to be laminated.

The beneficial effects of the present disclosure are as follows: With the above-described configuration, during operation, the machine housing body offers stable support for all components during operation, while the rotatably connected upper housing assembly facilitates device opening and closing operations. The detachable film roller assembly design permits convenient cold laminating film replacement and installation, thereby improving operational flexibility. The pressure roller assembly, including the cooperatively arranged fixed pressure roller and movable pressure roller, enables the movable pressure roller to move toward or away from the fixed pressure roller via the transmission assembly when opening or closing the upper housing assembly. This configuration ensures stable laminating pressure while facilitating both insertion and extraction of sheet materials, thereby streamlining operational procedures. The control handle allows intuitive control of the laminating process, enhancing overall usability. The integrated structure demonstrates clearly defined component functionality and efficient coordination, successfully balancing operational convenience with laminating stability, and consequently improving both efficiency and quality in manual cold laminating operations.

### BRIEF DESCRIPTION OF DRAWINGS

In order to explain the technical solutions of the embodiments of the present disclosure more clearly, the following will briefly introduce the accompanying drawings used in the embodiments. The drawings in the following description are only some embodiments of the present disclosure. Those of ordinary skill in the art can obtain other drawings based on these drawings without creative work.

The present disclosure is further described below in detail in combination with the accompanying drawings and embodiments.

FIG. 1 is a schematic structural view of the manual cold laminating machine according to the present disclosure, showing a first perspective with the control handle unfolded and the upper housing assembly closed;

FIG. 2 is a schematic structural view of the manual cold laminating machine according to the present disclosure, showing a second perspective with the control handle unfolded and the upper housing assembly closed;

FIG. 3 is a schematic structural view of the manual cold laminating machine according to the present disclosure, showing a perspective with the control handle unfolded and the upper housing assembly open;

FIG. 4 is a schematic structural view of the manual cold laminating machine according to the present disclosure, showing a perspective with the control handle folded and the upper housing assembly closed;

FIG. 5 is an exploded view of the manual cold laminating machine according to the present disclosure, showing the first perspective with the control handle unfolded and the upper housing assembly closed;

FIG. 6 is an exploded view of the manual cold laminating machine according to the present disclosure, showing the second perspective with the control handle unfolded and the upper housing assembly closed;

FIG. 7 is an exploded view of the upper housing assembly of the manual cold laminating machine according to the present disclosure, showing a perspective with the control handle unfolded and the upper housing assembly closed;

FIG. 8 is an exploded view of the film roller frame of the manual cold laminating machine according to the present disclosure, showing a perspective with the control handle unfolded and the upper housing assembly closed;

FIG. 9 is an exploded view of the transmission assembly of the manual cold laminating machine according to the present disclosure, showing a perspective with the control handle unfolded and the upper housing assembly closed;

FIG. 10 is a cross-sectional view of the transmission assembly of the manual cold laminating machine according to the present disclosure, showing a perspective with the control handle unfolded and the upper housing assembly closed;

FIG. 11 is an enlarged view of an area circled as A in FIG. 10;

FIG. 12 is a schematic partial structural view of the manual cold laminating machine according to the present disclosure, with the control handle unfolded and the upper housing assembly closed;

FIG. 13 is a schematic partial structural view of the manual cold laminating machine according to the present disclosure, with the control handle unfolded and the upper housing assembly open; and

FIG. 14 is an exploded view of the film roller frame of the manual cold laminating machine according to the present disclosure, showing a perspective with the control handle unfolded and the upper housing assembly closed.

### DETAILED DESCRIPTION OF THE INVENTION

To make the aforementioned objectives, features, and advantages of the present disclosure more comprehensible, specific implementations of the present disclosure are described in detail below in conjunction with the accompanying drawings. In the following description, numerous specific details are set forth to provide a thorough understanding of the present disclosure. The present disclosure may, however, be embodied in many forms different from that described here. A person skilled in the art can make similar improvements without departing from the connotation of the present disclosure. Therefore, the present disclosure is not limited by the specific embodiments disclosed below.

In the description of the present disclosure, It is to be understood that, The terms “center”, “longitudinal”, “transverse”, “upper”, “lower”, “front”, “rear”, “left”, “right”, “vertical”, “horizontal”, “top”, “bottom”, “inner”, “outer”, “clockwise”, “counterclockwise”, and the like indicate azimuth or positional relationships based on the azimuth or positional relationships shown in the drawings, For purposes of convenience only of describing the present disclosure and simplifying the description, Rather than indicating or implying that the indicated device or element must have a particular orientation, be constructed and operated in a particular orientation, therefore, not to be construed as limiting the present disclosure.

In addition, the terms “first” and “second” are used for descriptive purposes only, while not to be construed as indicating or implying relative importance or implicitly specifying the number of technical features indicated thereby, features defining “first,” “second,” and “second” may explicitly or implicitly include one or more of the described features. In the description of the present disclosure, “multiple” means two or more unless explicitly specified otherwise.

In addition, the terms “install”, “arrange”, “provide”, “connect” and “couple” should be understood broadly. For example, it can be a fixed connection, a detachable connection, an integral structure, a mechanical connection, an electrical connection, a direct connection, an indirect connection through an intermediate medium, or a communication between two devices, elements or components. For ordinary technical personnel in this field, the specific meanings of the above terms in present disclosure can be understood based on specific circumstances.

In the present disclosure, unless specific regulation and limitation otherwise, the first feature “onto” or “under” the second feature may include the direct contact of the first feature and the second feature, or may include the contact of the first feature and the second feature through other features between them instead of direct contact. Moreover, the first feature “onto”, “above” and “on” the second feature includes that the first feature is right above and obliquely above the second feature, or merely indicates that the horizontal height of the first feature is higher than the second feature. The first feature “under”, “below” and “down” the second feature includes that the first feature is right above and obliquely above the second feature, or merely indicates that the horizontal height of the first feature is less than the second feature.

It should be noted that when an element is referred to as being “fixed to” another element, the element can be directly on another component or there can be a centered element. When an element is considered to be “connected” to another element, the element can be directly connected to another element or there may be a centered element. The terms “inner”, “outer”, “left”, “right”, and similar expressions used herein are for illustrative purposes only and do not necessarily represent the only implementation.

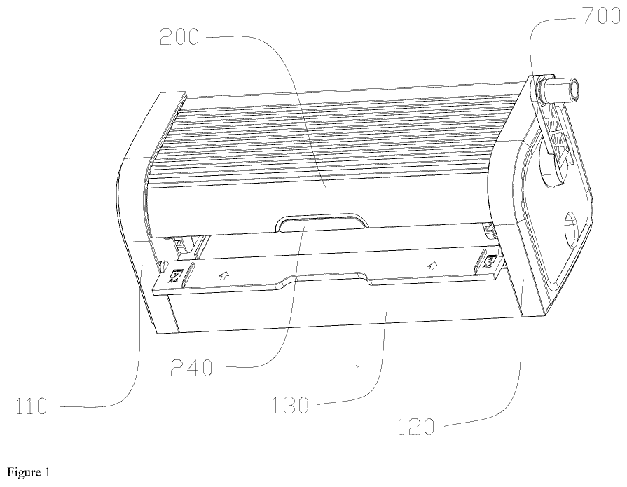

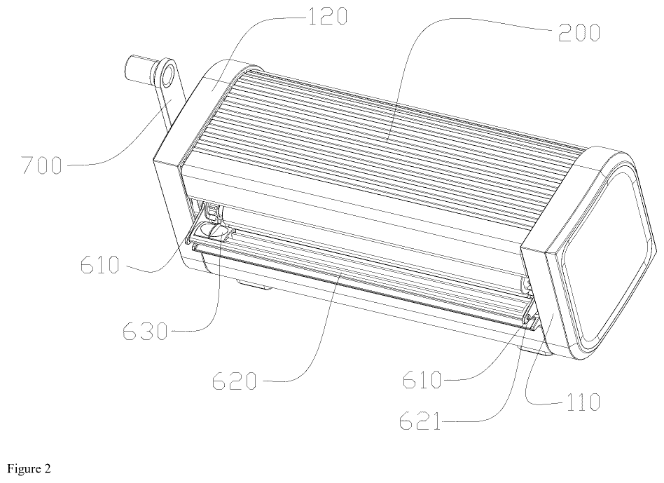

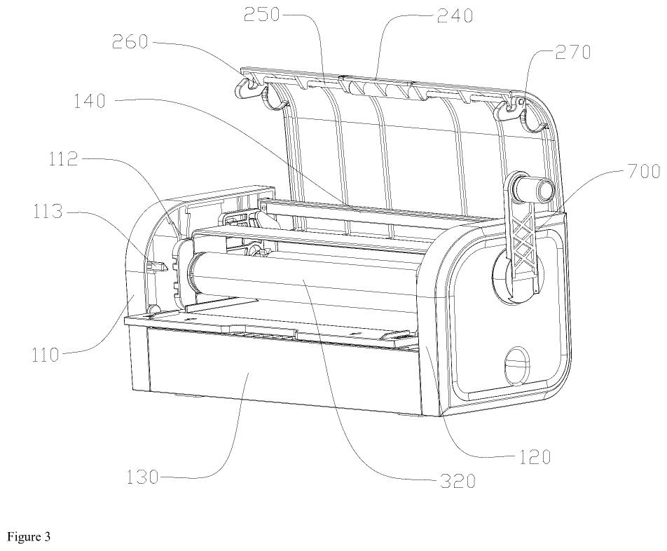

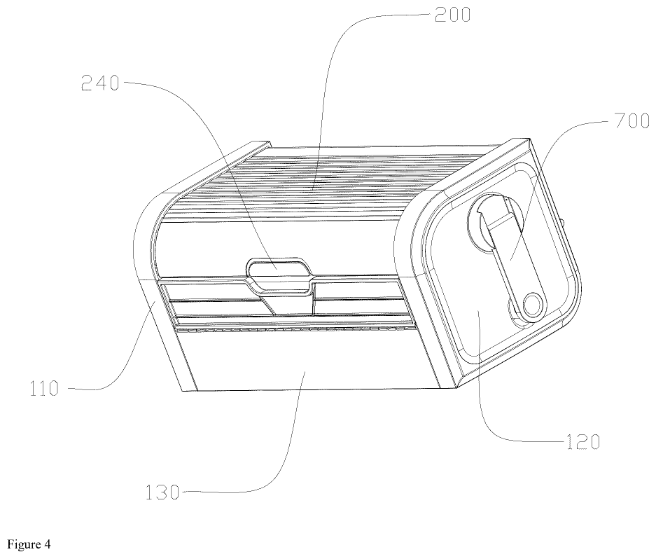

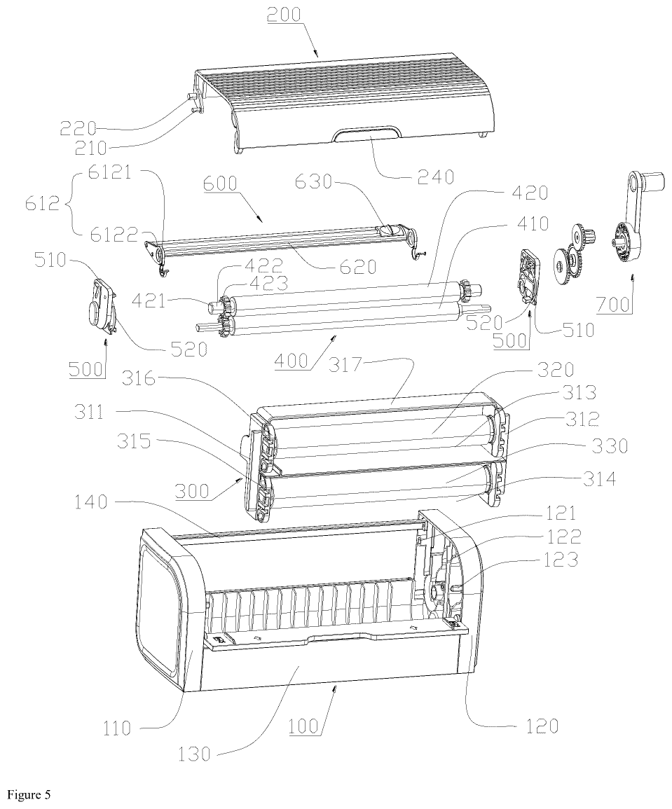

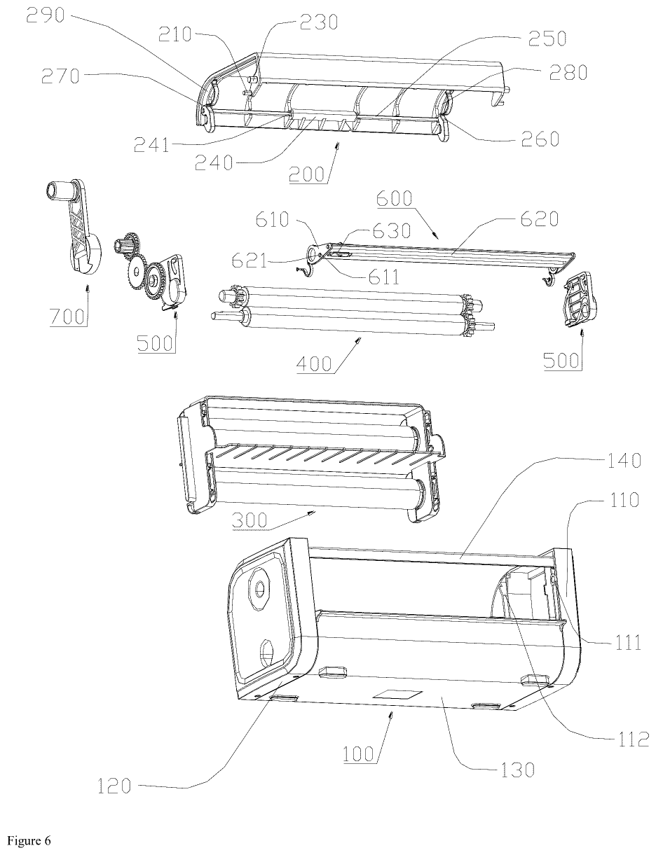

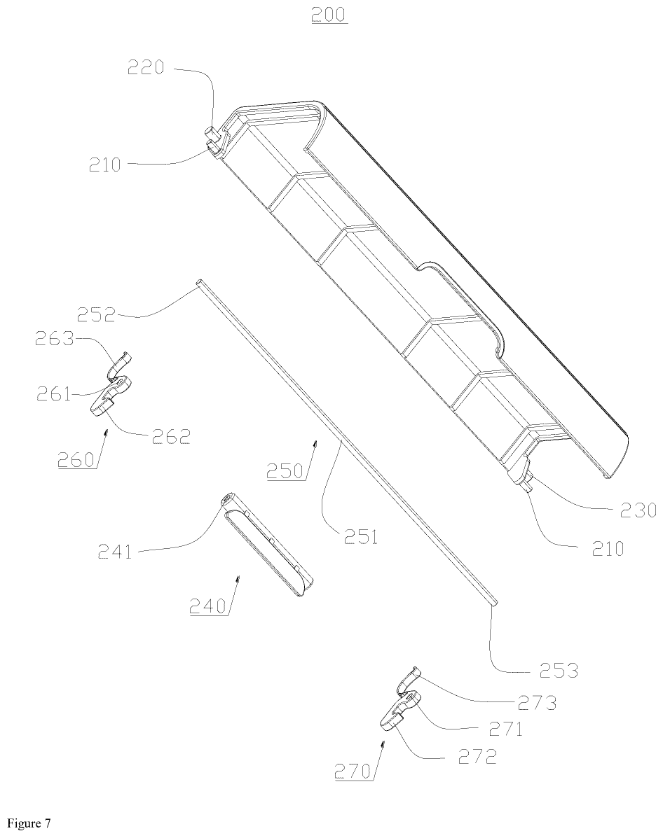

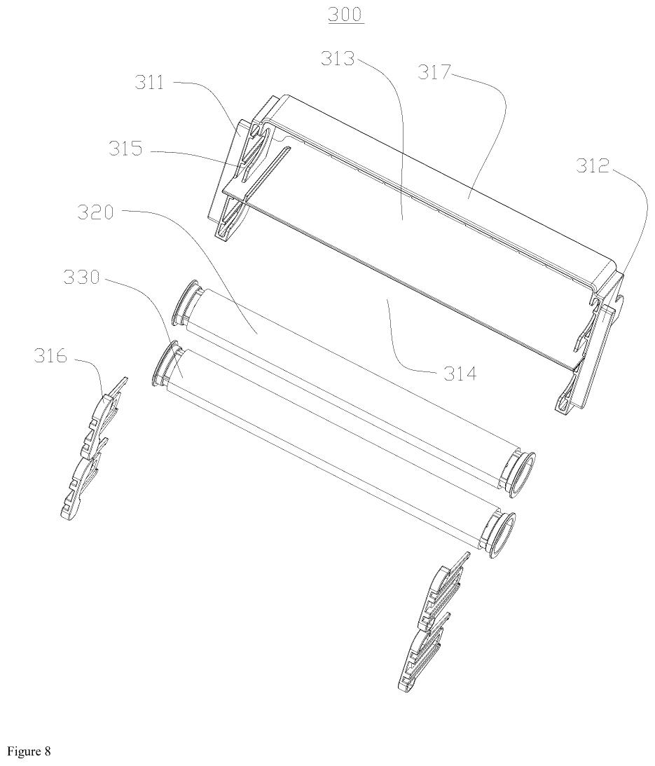

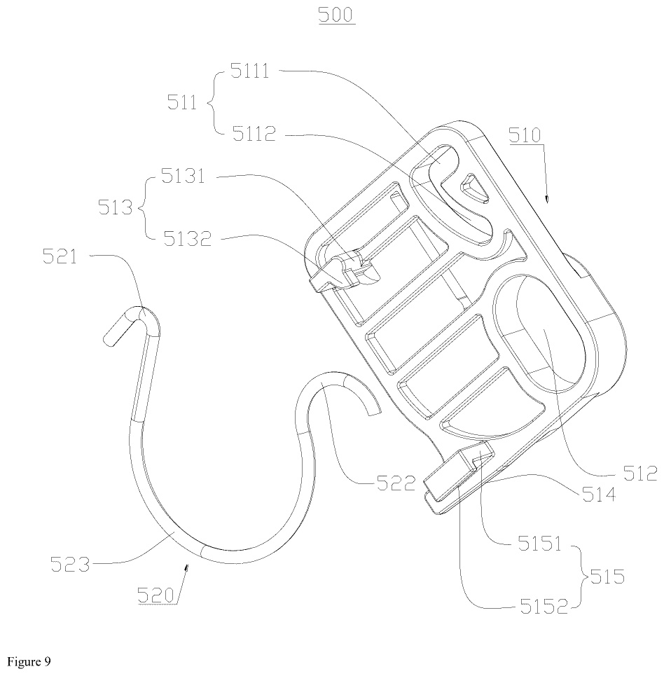

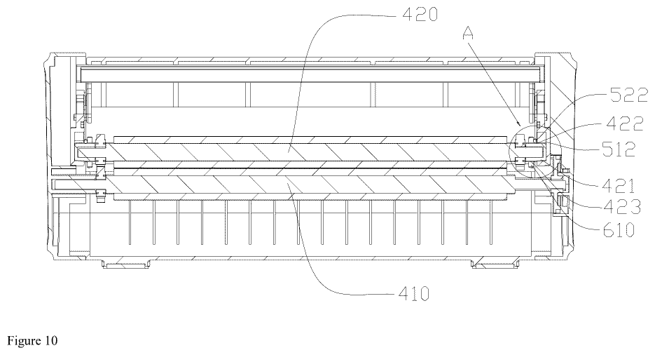

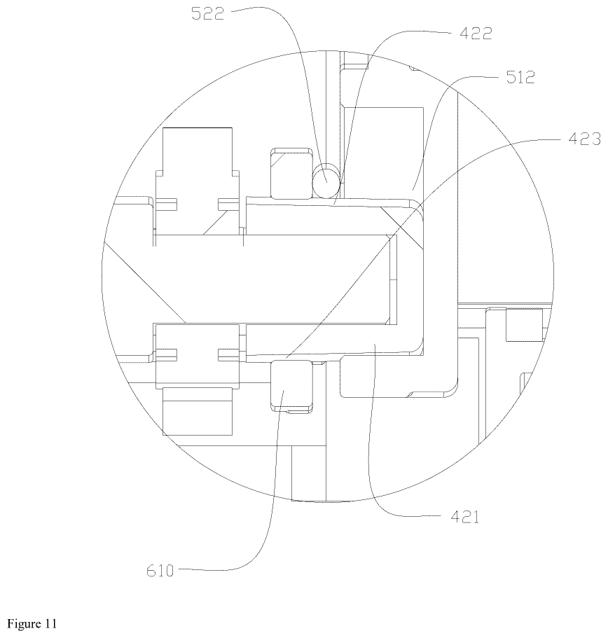

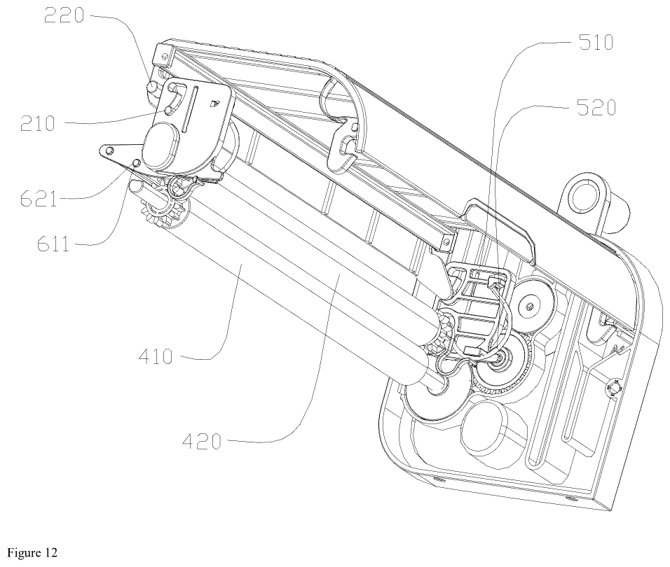

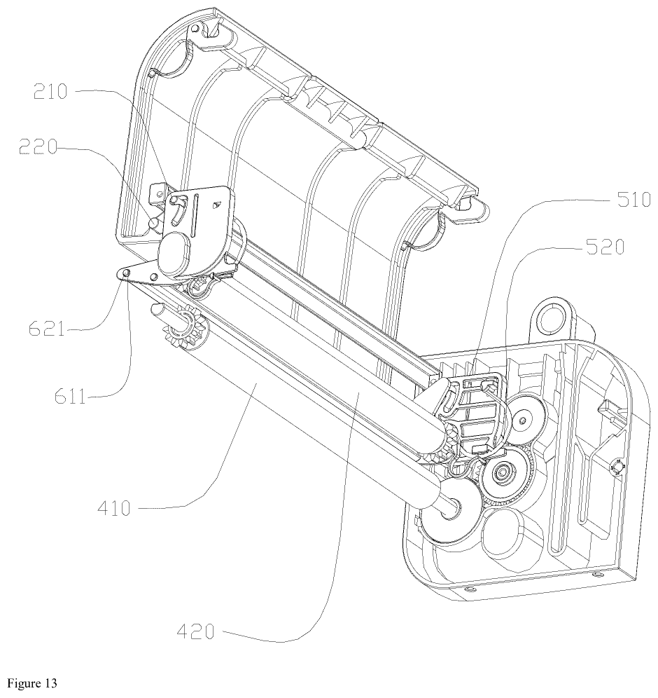

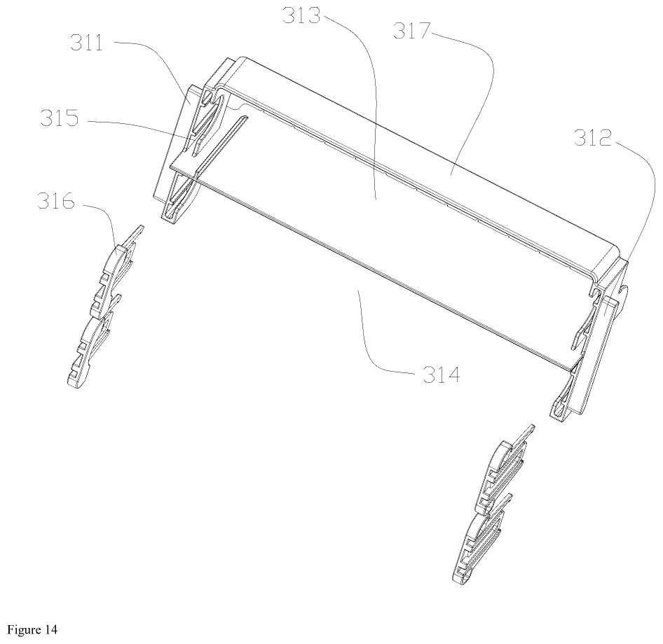

Referring to FIGS. 1 to 14, a manual cold laminating machine includes: a machine housing body 100;
an upper housing assembly 200 rotatably connected to the machine housing body 100;
a film roller assembly 300 detachably connected to the machine housing body 100;
a pressure roller assembly 400 connected to the machine housing body 100, wherein the pressure roller assembly 400 includes a fixed pressure roller 410 and a movable pressure roller 420, and the movable pressure roller 420 is selectively movable toward or away from the fixed pressure roller 410;
a transmission assembly 500, wherein when the upper housing assembly 200 is opened, rotational movement of the upper housing assembly 200 drives the movable pressure roller 420 via the transmission assembly 500 to move the movable pressure roller 420 away from the fixed pressure roller 410; and when the upper housing assembly 200 is closed, the rotational movement of the upper housing assembly 200 drives the movable pressure roller 420 via the transmission assembly 500 to move the movable pressure roller 420 toward the fixed pressure roller 410; and
a control handle 700 configured to control the manual cold laminating machine to apply a layer of cold laminating film onto a surface of a sheet to be laminated.

With the above-described configuration, during operation, the machine housing body 100 functions as the structural foundation, providing mounting support for all components including the upper housing assembly 200 and the film roller assembly 300, thereby ensuring overall structural stability of the device. The upper housing assembly 200, through its rotatable connection, enables both opening and closing motions. Its rotational movement serves dual functions: as direct operational input and as mechanical control that is converted through the transmission assembly 500 to operate the pressure roller assembly 400. In the open position, this mechanism drives the movable pressure roller 420 away from the fixed pressure roller 410 to permit insertion of sheets for lamination, while in the closed position it drives the movable pressure roller 420 toward the fixed pressure roller 410 to establish the requisite pressure for lamination. The film roller assembly 300 features a detachable design that facilitates convenient mounting and replacement of cold laminating film rolls, ensuring continuous supply of film for the lamination process. As the operational interface, the control handle 700 directly governs the device's operation by means of a gear assembly, controlling both the pressure roller assembly 400 and driving the cold laminating film across the sheet surface to complete the lamination process. All components are mechanically integrated to form a coordinated system that systematically provides structural support, operational input, film supply, pressure regulation, and process execution, ensuring a precise and reliable cold lamination process.

In this embodiment, the transmission assembly 500 includes a transmission plate 510. The transmission plate 510 is provided with an upper cover connecting groove 511 and a pressure roller mounting groove 512. The upper housing assembly 200 includes a transmission connecting portion 210, and the movable pressure roller 420 is provided with an actuation connecting portion 421. The transmission connecting portion 210 is connected to the upper cover connecting groove 511, and the actuation connecting portion 421 is connected to the pressure roller mounting groove 512. When the upper housing assembly 200 is opened, rotational movement of the upper housing assembly 200 drives the transmission plate 510 via cooperation between the transmission connecting portion 210 and the upper cover connecting groove 511, thereby causing the movable pressure roller 420 to move away from the fixed pressure roller 410 via cooperation between the pressure roller mounting groove 512 and the actuation connecting portion 421; conversely, when the upper housing assembly 200 is closed, rotational movement of the upper housing assembly 200 drives the transmission plate 510 via cooperation between the transmission connecting portion 210 and the upper cover connecting groove 511, thereby causing the movable pressure roller 420 to move toward the fixed pressure roller 410 via cooperation between the pressure roller mounting groove 512 and the actuation connecting portion 421. With the above-described configuration, the transmission assembly 500 functions as the critical linkage that interconnects the upper housing assembly 200 and the movable pressure roller 420 during operation. The transmission plate 510 acts as the core driving element. It stably receives and transfers the rotational movement from the upper housing assembly 200 via the cooperation between its upper cover connecting groove 511 and the transmission connecting portion 210. Simultaneously, it converts this motion into a linear displacement of the movable pressure roller 420 via the cooperation between its pressure roller mounting groove 512 and the actuation connecting portion 421. Specifically, opening the upper housing assembly 200 causes the transmission connecting portion 210 to actuate the transmission plate 510 via the upper cover connecting groove 511. This action is then precisely translated through the interaction of the pressure roller mounting groove 512 and the actuation connecting portion 421 to drive the movable pressure roller 420 away from the fixed pressure roller 410. The closing operation follows the same kinematic path in reverse to move the movable pressure roller 420 toward the fixed pressure roller 410. This design ensures efficient motion transfer and conversion through direct mechanical cooperation, guaranteeing synchronization and accuracy between the operation of the upper housing assembly 200 and the movement of the movable pressure roller 420. It thereby provides a reliable mechanical foundation for controlling the opening and closing of the pressure rollers during the cold lamination process.

In this embodiment, the transmission assembly 500 further includes an elastic member 520. The elastic member is provided with a transmission abutment portion 521 and an actuation abutment portion 522. The transmission plate 510 is further provided with a first abutting support portion 513. The movable pressure roller 420 is further provided with a preload abutment portion 422. The transmission abutment portion 521 abuts against the first abutting support portion 513. The actuation abutment portion 522 abuts against the preload abutment portion 422 and provides a preload force to the movable pressure roller 420 via the preload abutment portion 422. The preload force is in a range from 3 Newtons (3 N) to 25 Newtons (25 N). With the above-described configuration, the structural design of the elastic member 520 within the transmission assembly 500 further optimizes the operational performance of the movable pressure roller 420. Specifically, the elastic member 520, via its transmission abutment portion 521 abutting against the first abutting support portion 513 of the transmission plate 510, and its actuation abutment portion 522 cooperating with the preload abutment portion 422 of the movable pressure roller 420, applies the preload force within the 3 N to 25 N range. This preload force ensures that when the movable pressure roller 420 moves toward the fixed pressure roller 410, stable contact pressure is maintained even in the presence of minor assembly tolerances or transmission backlash, thereby preventing lamination issues such as air bubbles and poor adhesion caused by insufficient pressure. Concurrently, the specified range of 3 N to 25 N is sufficient to ensure effective bonding between the cold laminating film and the sheet to be laminated, yet is carefully calibrated to avoid damage to either the sheet or the film that could result from excessive pressure. The mechanical cooperation of the elastic member 520 with the transmission plate 510 and the movable pressure roller 420 effectively converts elastic force into a controllable preload. This preload function thus complements the driving function of the transmission plate 510, ensuring that the movement of the movable pressure roller 420 is not only synchronized and precise but also maintains a consistent working pressure, significantly enhancing the quality and reliability of the cold lamination process.

In this embodiment, the first abutting support portion 513 is provided with an abutment protrusion 5131 and a limiting protrusion 5132 extending from a terminal end of the abutment protrusion 5131. The transmission abutment portion 521 abuts against the abutment protrusion 5131. The limiting protrusion 5132 is configured to limit lateral displacement of the transmission abutment portion 521. With the above-described configuration, during operation, the configuration of the abutment protrusion 5131 and the limiting protrusion 5132 of the first abutting support portion 513 provides critical support for ensuring stable engagement between the elastic member 520 and the transmission plate 510. Specifically, the abutment protrusion 5131 functions as a direct force-receiving point, providing a defined and stable abutting foundation for the transmission abutment portion 521, thereby avoiding loss or fluctuation of preload force due to ambiguous contact area or shifted force application points. Meanwhile, the limiting protrusion 5132, which extends from the terminal end of the abutment protrusion 5131, effectively constrains lateral displacement of the transmission abutment portion 521, preventing transverse shifting of the elastic member 520 during force-induced deformation or operation of the device. This ensures that the transmission abutment portion 521 maintains precise engagement with the abutment protrusion 5131 at all times. The combination of these features not only enhances the force transmission efficiency between the elastic member 520 and the transmission plate 510, but also maintains engagement stability through structural confinement. Thereby, reliable support is provided for sustaining a consistent preload force on the movable pressure roller 420, further improving the operational reliability of the entire transmission system.

In this embodiment, the manual cold laminating machine further includes an edge-cutting assembly 600. The edge-cutting assembly 600 includes a mounting member 610, a guide rail member 620 fixedly connected to the mounting member 610, and a cutting member 630 slidably connected to the guide rail member 620. The movable pressure roller 420 is provided with an accessory connecting portion 423, and the mounting member 610 is connected to the accessory connecting portion 423. With the above-described configuration, during operation, the edge-cutting assembly 600 provides convenient edge-cutting functionality for cold laminating operations, enabling highly efficient synergy with the main body of the apparatus. Specifically, by connecting to the accessory connecting portion 423 provided at both ends of the movable pressure roller 420, the mounting member 610 securely mounts the entire edge-cutting assembly 600 onto the movable pressure roller 420. This allows the edge-cutting operation to follow the movement of the movable pressure roller 420 synchronously, ensuring that the cutting position corresponds with the lamination progress. The guide rail member 620, fixed to the mounting member 610, provides a stable sliding track for the cutting member 630. The configuration allowing the cutting member 630 to slide along the guide rail member 620 enables adjustment of the cutting position according to the size of the sheet material to be laminated, accommodating edge-cutting requirements for materials of different specifications. This structure integrates the edge-cutting function with the movable pressure roller 420, eliminating the need for a separate cutting step after lamination. It not only simplifies the operational procedure but also ensures cutting accuracy through sliding adjustment, avoiding potential deviations associated with manual secondary cutting. Thereby, it further enhances the overall operational efficiency and finished product quality of the manual cold laminating machine.

In this embodiment, the mounting member 610 is provided with a guide rail mounting hole 611 and a mounting abutment portion 612. The guide rail member 620 is provided with a guide rail mounting shaft 621. The transmission plate 510 is further provided with a second abutting support portion 514. The guide rail mounting shaft 621 is cooperatively engaged with the guide rail mounting hole 611 to fixedly connect the guide rail member 620 to the mounting member 610. The mounting abutment portion 612 abuts against the second abutting support portion 514. With the above-described configuration, during operation, the cooperative configuration among the guide rail mounting hole 611 and the mounting abutment portion 612 of the mounting member 610, the guide rail mounting shaft 621 of the guide rail member 620, and the second abutting support portion 514 of the transmission plate 510, further enhances the stability and synergistic operation of the edge-cutting assembly 600. Specifically, the precise cooperative engagement between the guide rail mounting hole 611 and the guide rail mounting shaft 621 provides reliable positioning and secure fastening for fixedly connecting the guide rail member 620 to the mounting member 610. This ensures that the guide rail member 620 remains free from loosening or displacement during sliding movement of the cutting member 630, thereby establishing a foundation for stable sliding of the cutting member 630. Meanwhile, the abutment of the mounting abutment portion 612 against the second abutting support portion 514 of the transmission plate 510 provides an additional support point for the mounting member 610 via the transmission plate 510. This distributes the force exerted on the connection area between the mounting member 610 and the movable pressure roller 420, preventing deformation of the mounting structure due to forces generated during edge-cutting operations. Concurrently, this arrangement creates a tighter linkage between the edge-cutting assembly 600 and the transmission system, reducing vibration during cutting and improving cutting accuracy. This structural design optimizes the operational state of the edge-cutting assembly 600 from both connection stability and force support aspects, further ensuring the precision and reliability of the edge-cutting operation.

In this embodiment, the transmission plate 510 is further provided with a third abutting support portion 515. The elastic member 520 is further provided with an intermediate abutment portion 523, and the intermediate abutment portion 523 abuts against the third abutting support portion 515. With the above-described configuration, during operation, the cooperation between the third abutting support portion 515 of the transmission plate 510 and the intermediate abutment portion 523 of the elastic member 520 further enhances the operational stability of the elastic member 520. The intermediate abutment portion 523 abutting against the third abutting support portion 515 adds an additional force-bearing support point for the elastic member 520, enabling the elastic member 520 to experience a more balanced force during deformation and force transmission, thereby avoiding tilting or misalignment that may occur with single-point support. Simultaneously, this multi-point support structure can effectively disperse the reaction force experienced by the elastic member 520, reducing fatigue damage caused by long-term stress and extending its service life, thereby stably and continuously providing a preload force to the movable pressure roller 420 and ensuring the stability of pressure during cold laminating operations.

In this embodiment, the third abutting support portion 515 is provided with an abutment boss 5151 and a limiting boss 5152 extending from a terminal end of the abutment boss 5151. The intermediate abutment portion 523 abuts against the abutment boss 5151. The limiting boss 5152 is configured to limit lateral displacement of the intermediate abutment portion 523. With the above-described configuration, during operation, the abutment boss 5151 and the limiting boss 5152 of the third abutting support portion 515 further enhance the cooperative effect with the intermediate abutment portion 523 of the elastic member 520: the abutment boss 5151 provides a precise abutment point for the intermediate abutment portion 523, ensuring concentrated and stable force transmission; the limiting boss 5152 limits lateral displacement of the intermediate abutment portion 523, preventing the elastic member 520 from shifting during force transmission or deformation. The combination of both ensures more reliable multi-point support of the elastic member and more precise force transmission, thereby further ensuring stable output of the preload force and enhancing pressure stability during cold laminating operations.

In this embodiment, the upper cover connecting groove 511 includes a locking groove portion 5111 and a curved groove portion 5112. The locking groove portion 5111 is connected to the curved groove portion 5112. When the upper housing assembly 200 is opened, the transmission connecting portion 210 is positioned within the locking groove portion 5111; and when the upper housing assembly 200 is closed, the transmission connecting portion 210 is positioned within the curved groove portion 5112. With the above-described configuration, during operation, when the upper housing assembly 200 is opened, the transmission connecting portion 210 being positioned within the locking groove portion 5111 stably limits the position of the transmission plate 510, preventing unintended movement of the movable pressure roller 420; when the upper housing assembly 200 is closed, the transmission connecting portion 210 enters the curved groove portion 5112 and guides the smooth movement of the transmission plate 510 through a curved trajectory, driving the movable pressure roller 420 to accurately approach the fixed pressure roller 410. This design not only ensures state stability during equipment opening and closing but also guarantees smoothness of the transmission process, thereby enhancing operational reliability.

In this embodiment, the machine housing body 100 includes a first sidewall housing 110, a second sidewall housing 120 and a base housing 130. A lower end of the first sidewall housing 110 is fixedly connected to an end of the base housing 130; and a lower end of the second sidewall housing 120 is fixedly connected to the other end of the base housing 130. With the above-described configuration, during operation, the structural design of the first sidewall housing 110, the second sidewall housing 120 and the base housing 130 of the housing body 100 provides a stable frame foundation for the equipment: the lower ends of the first sidewall housing 110 and the second sidewall housing 120 are respectively fixedly connected to both ends of the base housing 130, forming a symmetrical bilateral support structure capable of uniformly bearing the weight of components such as the upper housing assembly 200 and the pressure roller assembly 400; the base housing 130 functions as a bottom support, enhancing the overall stability of the equipment and preventing shaking during operation. This structure not only provides a reliable mounting carrier for various components but also ensures structural stability during equipment operation.

In this embodiment, the machine housing body 100 further includes a reinforcement member 140. An end of the reinforcement member 140 is fixedly connected to an upper end of the first sidewall housing 110; and the other end of the reinforcement member 140 is fixedly connected to an upper end of the second sidewall housing 120. The reinforcement member 140 is configured to reinforce the machine housing body 100. With the above-described configuration, during operation, the reinforcement member 140 of the housing body 100 further enhances the overall structural stability: with one end fixed to the upper end of the first sidewall housing 110 and the other end fixed to the upper end of the second sidewall housing 120, it forms a corresponding connection structure with the base housing 130 at both upper and lower levels. more tightly integrating the two sidewall housings as a unified body. This effectively resists lateral forces and deformation generated during component mounting and operation, preventing outward expansion or shaking at the upper ends of the sidewall housings. Consequently, the load-bearing capacity and structural stability of the housing body 100 are significantly improved. providing a more reliable frame guarantee for long-term stable operation of the equipment.

In this embodiment, the first sidewall housing 110 is provided with a first mounting portion 111. The second sidewall housing 120 is provided with a second mounting portion 121. The upper housing assembly 200 is provided with a third mounting portion 220 and a fourth mounting portion 230. The first mounting portion 111 is rotatably connected to the third mounting portion 220; and the second mounting portion 121 is rotatably connected to the fourth mounting portion 230, whereby the upper housing assembly 200 is rotatably connected to the first sidewall housing 110 and the second sidewall housing 120. With the above-described configuration, during operation, the rotatable connection structure between the first mounting portion 111 of the first sidewall housing 110 and the second mounting portion 121 of the second sidewall housing 120 with the third mounting portion 220 and the fourth mounting portion 230 of the upper housing assembly 200 provides a stable rotational foundation for the opening and closing of the upper housing assembly 200: the bilaterally symmetrical rotational connection points ensure that the upper housing assembly 200 experiences balanced force during rotation, preventing unilateral tilting or jamming; this connection method not only enables flexible rotation of the upper housing assembly 200 relative to the housing body 100, facilitating the insertion of workpieces to be processed and equipment operation, but also ensures smoothness of the rotation process. This provides a reliable mechanical foundation for subsequently driving the movable pressure roller 420 through the transmission assembly 500, thereby enhancing the smoothness and stability of equipment operation.

In this embodiment, the film roller assembly 300 includes a film roller frame 310. An end of the film roller frame 310 is provided with a first sliding rail strip 311, and the other end of the film roller frame 310 is provided with a second sliding rail strip 312. The first sidewall housing 110 is provided with a first mounting sliding rail 112. The second sidewall housing 120 is provided with a second mounting sliding rail 122. The first sliding rail strip 311 is slidably connected to the first mounting sliding rail 112; and the second sliding rail strip 312 is slidably connected to the second mounting sliding rail 122, whereby the film roller frame 310 is detachably connected to the first sidewall housing 110 and the second sidewall housing 120. With the above-described configuration, during operation, the film roller frame 310 of the film roller assembly 300 forms a sliding connection through the first sliding rail strip 311 and the second sliding rail strip 312 with the first mounting sliding rail 112 of the first sidewall housing 110 and the second mounting sliding rail 122 of the second sidewall housing 120, achieving a detachable design of the film roller frame 310: the bilaterally symmetrical rail engagement structure enables the film roller frame 310 to slide smoothly along the rails, facilitating quick installation or removal; this connection method not only ensures the stability of the film roller frame 310 after installation, preventing shaking during operation, but also simplifies the operational process for replacing cold laminating films, thereby enhancing the usability of the equipment and providing support for efficiently completing cold laminating operations.

In this embodiment, the film roller assembly 300 further includes a first film roller 320 and a second film roller 330. The film roller frame 310 defines a first mounting space 313 and a second mounting space 314. The first film roller 320 is detachably mounted in the first mounting space 313; and the second film roller 330 is detachably mounted in the second mounting space 314. With the above-described configuration, during operation, the first film roller 320 and the second film roller 330 of the film roller assembly 300 are respectively detachably mounted in the first mounting space 313 and the second mounting space 314 of the film roller frame 310, further optimizing the operational flexibility of the equipment: independent mounting spaces provide precise positioning for the two film rollers, ensuring stable positioning after installation; the detachable design facilitates individual replacement of either film roller, making operations more convenient whether replacing cold laminating films of different specifications or performing maintenance on the film rollers; the dual-film-roller configuration can also accommodate simultaneous placement of different types of cold laminating films, enhancing the equipment's adaptability to diverse operational scenarios and supporting efficient execution of cold laminating operations. It is to be noted that the film roller assembly 300 further includes a film roller frame grip 317. The film roller frame grip 317 is configured to provide a gripping space to facilitate installation and removal of the film roller assembly 300. It is to be noted that since the first film roller 320 and the second film roller 330 are respectively detachably mounted in the first mounting space 313 and the second mounting space 314 of the film roller frame 310, both the first film roller 320 and the second film roller 330 can be replaced individually. Unlike existing products on the market that require replacement of the entire film roller assembly, only the corresponding depleted film roller needs to be replaced.

In this embodiment, the film roller frame 310 defines a plurality of clamping grooves 315 and a plurality of clamping plates 316 matching the clamping grooves 315. The clamping grooves 315 are disposed on opposite sides of the first mounting space 313 and the second mounting space 314. The film roller frame 310 detachably mounts the first film roller 320 in the first mounting space 313 and the second film roller 330 in the second mounting space 314, by clamping engagement between the clamping plates 316 and the clamping grooves 315. With the above-described configuration, during operation, the cooperation between the clamping grooves 315 and the clamping plates 316 of the film roller frame 310 provides a reliable structure for detachable mounting of the first film roller 320 and the second film roller 330: the clamping grooves 315 are respectively disposed on opposite sides of the first mounting space 313 and the second mounting space 314, forming precise clamping engagement with the clamping plates 316, which not only securely fixes the film rollers to prevent shaking or dislodgement during operation, ensuring mounting stability, but also enables quick loading and unloading of the film rollers through simple clamping and separation operations, making replacement or maintenance of the film rollers more convenient. This structure enhances both the stability of film roller mounting and the convenience of operation, further improving the operational effectiveness of the film roller assembly 300.

In this embodiment, the upper housing assembly 200 further includes a control switch 240. When the upper housing assembly 200 is closed, it is in a default locked state that limits rotational movement; upon pressing the control switch 240, the upper housing assembly 200 switches from the default locked state to an unlocked state; and in the unlocked state, the upper housing assembly 200 is rotatable to switch from a closed state to an open state. With the above-described configuration, during operation, the design of the control switch 240 of the upper housing assembly 200 enhances both operational safety and controllability of the equipment: when the upper housing assembly 200 is closed and in the default locked state, the limitation of rotational movement prevents accidental opening during operation, thereby avoiding potential impacts on laminating precision or creating safety hazards; after pressing the control switch 240 to switch to the unlocked state, the upper housing assembly 200 becomes rotatable to open, ensuring both flexible operation when necessary and providing safety protection through the locking mechanism. This structure enables controllable state switching of the upper housing assembly 200, effectively balancing operational stability with operational safety.

In this embodiment, the upper housing assembly 200 further includes a latch limiting shaft 250, a first latch locking plate 260 and a second latch locking plate 270. The first sidewall housing 110 is provided with a first locking boss 113. The second sidewall housing 120 is provided with a second locking boss 123. The control switch 240 is provided with a latch limiting hole 241. The first latch locking plate 260 is provided with a first latch mounting hole 261 and a first locking hook 262. The second latch locking plate 270 is provided with a second latch mounting hole 271 and a second locking hook 272. The latch limiting shaft 250 includes a control shaft segment 251 disposed at a middle portion, a first mounting shaft segment 252 and a second mounting shaft segment 253 disposed at opposite ends. When the upper housing assembly 200 is closed: the first locking hook 262 engages with the first locking boss 113; and the second locking hook 272 engages with the second locking boss 123, thereby maintaining the upper housing assembly 200 in the default locked state. The control shaft segment 251 cooperates with the latch limiting hole 241, such that a pressing operation on the control switch 240 drives rotational movement of the latch limiting shaft 250. The first mounting shaft segment 252 engages with the first latch mounting hole 261, the second mounting shaft segment 253 engages with the second latch mounting hole 271, such that the rotational movement of the latch limiting shaft 250 drives rotational movements of the first latch locking plate 260 and the second latch locking plate 270, thereby switching the upper housing assembly 200 from the default locked state to the unlocked state. With the above-described configuration, during operation, the structures including the latch limiting shaft 250, the first latch locking plate 260, and the second latch locking plate 270 of the upper housing assembly 200 provide reliable mechanical support for switching between the default locked and unlocked states: when closed, the first locking hook 262 and the second locking hook 262 respectively engage with the first locking boss 113 and the second locking boss 123, ensuring secure default locking of the upper housing assembly 200 through dual locking to prevent accidental opening during operation; when pressing the control switch 240, its rotational movement drives the latch limiting shaft 250 to rotate through the latch limiting hole 241, and then through cooperation between the first mounting shaft segment 252 and the second mounting shaft segment 253 with the corresponding first latch mounting hole 261 and second latch mounting hole 271, drives the first latch locking plate 260 and the second latch locking plate 270 to rotate, causing the first locking hook 262 and the second locking hook 272 to disengage from the first locking boss 113 and the second locking boss 123 respectively to complete unlocking. This multi-component coordinated locking mechanism not only enhances the stability of the default locked state but also ensures precise controllability of the unlocking operation, further improving the safety and reliability of the equipment. The radial cross-section of the latch limiting shaft 250 has a D-like shape defined by an arc segment and a straight line segment.

In this embodiment, the upper housing assembly 200 further includes a first sliding abutment portion 280 and a second sliding abutment portion 290. The first latch locking plate 260 is further provided with a first elastic preload portion 263. The second latch locking plate 270 is further provided with a second elastic preload portion 273. A terminal end of the first elastic preload portion 263 abuts against the first sliding abutment portion 280. A terminal end of the second elastic preload portion 273 abuts against the second sliding abutment portion 290. When the upper housing assembly 200 is closed: the first locking hook 262 engages with the first locking boss 113 upon the elastic force generated by the first elastic preload portion 263; and the second locking hook 272 engages with the second locking boss 123 upon the elastic force generated by the second elastic preload portion 273, thereby maintaining the upper housing assembly 200 in the default locked state. With the above-described configuration, during operation, the cooperation between the first elastic preload portion 263 and the second elastic preload portion 273 of the upper housing assembly 200 with the corresponding first sliding abutment portion 280 and the second sliding abutment portion 290 further enhances the reliability of the default locked state: the terminal end of the first elastic preload portion 263 abuts against the first sliding abutment portion 280, and the terminal end of the second elastic preload portion 273 abuts against the second sliding abutment portion 290, generating elastic forces that respectively push the first locking hook 262 and the second locking hook 272 to tightly engage with the corresponding locking bosses, preventing locking loosening due to vibration or minor external forces; this elastic preload structure creates tighter clamping engagement between the locking hooks and the bosses, ensuring the stability of the upper housing assembly 200 in the default locked state and providing additional guarantee for safe equipment operation.

In this embodiment, the control handle 700 is configured to be foldable. With the above-described configuration, during operation, the foldable design of the control handle 700 significantly enhances the practicality of the equipment: when idle, folding the handle reduces the overall space occupied by the equipment, facilitating storage and placement; during transportation or carrying, the folded state prevents damage caused by impact to the handle and also saves transportation space; meanwhile, the folding design does not affect its normal operational functions, enhancing the portability and spatial adaptability of the equipment while ensuring operational convenience.

The embodiments described above are provided to illustrate the present disclosure in conjunction with specific implementations, and are not intended to limit the scope of the disclosure to these descriptions. Any methods, structures, or techniques that are similar or equivalent to those disclosed herein, or any technical deductions or substitutions made based on the concept of the present disclosure, shall fall within the protection scope of the present disclosure.

1. A manual cold laminating machine, comprising:
a machine housing body;
an upper housing assembly rotatably connected to the machine housing body;
a film roller assembly detachably connected to the machine housing body;
a pressure roller assembly connected to the machine housing body, wherein the pressure roller assembly comprises a fixed pressure roller and a movable pressure roller, and the movable pressure roller is selectively movable toward or away from the fixed pressure roller;
a transmission assembly, wherein when the upper housing assembly is opened, rotational movement of the upper housing assembly drives the movable pressure roller via the transmission assembly to move the movable pressure roller away from the fixed pressure roller; and when the upper housing assembly is closed, the rotational movement of the upper housing assembly drives the movable pressure roller via the transmission assembly to move the movable pressure roller toward the fixed pressure roller; and
a control handle configured to control the manual cold laminating machine to apply a layer of cold laminating film onto a surface of a sheet to be laminated.

2. The manual cold laminating machine according to claim 1, wherein:
the transmission assembly comprises a transmission plate;
the transmission plate is provided with an upper cover connecting groove and a pressure roller mounting groove;
the upper housing assembly comprises a transmission connecting portion;
the movable pressure roller is provided with an actuation connecting portion;
the transmission connecting portion is connected to the upper cover connecting groove;
the actuation connecting portion is connected to the pressure roller mounting groove;
when the upper housing assembly is opened, rotational movement of the upper housing assembly drives the transmission plate via cooperation between the transmission connecting portion and the upper cover connecting groove, thereby causing the movable pressure roller to move away from the fixed pressure roller via cooperation between the pressure roller mounting groove and the actuation connecting portion; and when the upper housing assembly is closed, rotational movement of the upper housing assembly drives the transmission plate via cooperation between the transmission connecting portion and the upper cover connecting groove, thereby causing the movable pressure roller to move toward the fixed pressure roller via cooperation between the pressure roller mounting groove and the actuation connecting portion.

3. The manual cold laminating machine according to claim 2, wherein:
the transmission assembly further comprises an elastic member;
the elastic member is provided with a transmission abutment portion and an actuation abutment portion;
the transmission plate is further provided with a first abutting support portion;
the movable pressure roller is further provided with a preload abutment portion;
the transmission abutment portion abuts against the first abutting support portion; and
the actuation abutment portion abuts against the preload abutment portion and provides a preload force to the movable pressure roller via the preload abutment portion.

4. The manual cold laminating machine according to claim 3, wherein:
the first abutting support portion is provided with an abutment protrusion and a limiting protrusion extending from a terminal end of the abutment protrusion;
the transmission abutment portion abuts against the abutment protrusion; and
the limiting protrusion is configured to limit lateral displacement of the transmission abutment portion.

5. The manual cold laminating machine according to claim 4, further comprising:
an edge-cutting assembly comprising:
a mounting member;
a guide rail member fixedly connected to the mounting member; and
a cutting member slidably connected to the guide rail member;
wherein the movable pressure roller is provided with an accessory connecting portion, and the mounting member is connected to the accessory connecting portion.

6. The manual cold laminating machine according to claim 5, wherein:
the mounting member is provided with a guide rail mounting hole and a mounting abutment portion;
the guide rail member is provided with a guide rail mounting shaft;
the transmission plate is further provided with a second abutting support portion;
the guide rail mounting shaft is engaged with the guide rail mounting hole to fixedly connect the guide rail member to the mounting member; and
the mounting abutment portion abuts against the second abutting support portion.

7. The manual cold laminating machine according to claim 6, wherein:
the mounting abutment portion is provided with an abutment block and a limiting block extending from an end of the abutment block;
the transmission abutment portion abuts against the abutment block; and
the limiting block is configured to limit lateral displacement of the second abutting support portion.

8. The manual cold laminating machine according to claim 7, wherein:
the transmission plate is further provided with a third abutting support portion;
the elastic member is further provided with an intermediate abutment portion; and
the intermediate abutment portion abuts against the third abutting support portion.

9. The manual cold laminating machine according to claim 8, wherein:
the third abutting support portion is provided with an abutment boss and a limiting boss extending from a terminal of the abutment boss;
the intermediate abutment portion abuts against the abutment boss; and
the limiting boss is configured to limit lateral displacement of the intermediate abutment portion.

10. The manual cold laminating machine according to claim 2, wherein:
the upper cover connecting groove comprises:
a locking groove portion; and
a curved groove portion connected to the locking groove portion;
when the upper housing assembly is opened, the transmission connecting portion is positioned within the locking groove portion; and
when the upper housing assembly is closed, the transmission connecting portion is positioned within the curved groove portion.

11. The manual cold laminating machine according to claim 1, wherein:
the machine housing body comprises:
a first sidewall housing;
a second sidewall housing; and
a base housing;
a lower end of the first sidewall housing is fixedly connected to an end of the base housing; and a lower end of the second sidewall housing is fixedly connected to the other end of the base housing.

12. The manual cold laminating machine according to claim 11, wherein:
the machine housing body further comprises a reinforcement member;
an end of the reinforcement member is fixedly connected to an upper end of the first sidewall housing;
the other end of the reinforcement member is fixedly connected to an upper end of the second sidewall housing; and
the reinforcement member is configured to reinforce the machine housing body.

13. The manual cold laminating machine according to claim 11, wherein:
the first sidewall housing is provided with a first mounting portion;
the second sidewall housing is provided with a second mounting portion;
the upper housing assembly is provided with a third mounting portion and a fourth mounting portion;
the first mounting portion is rotatably connected to the third mounting portion; and
the second mounting portion is rotatably connected to the fourth mounting portion,
whereby the upper housing assembly is rotatably connected to the first sidewall housing and the second sidewall housing.

14. The manual cold laminating machine according to claim 11, wherein:
the film roller assembly comprises a film roller frame;
an end of the film roller frame is provided with a first sliding rail strip;
the other end of the film roller frame is provided with a second sliding rail strip;
the first sidewall housing is provided with a first mounting sliding rail;
the second sidewall housing is provided with a second mounting sliding rail;
the first sliding rail strip is slidably connected to the first mounting sliding rail; and the second sliding rail strip is slidably connected to the second mounting sliding rail, whereby the film roller frame is detachably connected to the first sidewall housing and the second sidewall housing.

15. The manual cold laminating machine according to claim 14, wherein:
the film roller assembly further comprises:
a first film roller; and
a second film roller;
the film roller frame defines:
a first mounting space; and
a second mounting space;
the first film roller is detachably mounted in the first mounting space; and
the second film roller is detachably mounted in the second mounting space.

16. The manual cold laminating machine according to claim 15, wherein:
the film roller frame defines:
a plurality of clamping grooves; and
a plurality of clamping plates matching the clamping grooves;
the clamping grooves are disposed on opposite sides of the first mounting space and the second mounting space;
the film roller frame detachably mounts:
the first film roller in the first mounting space; and
the second film roller in the second mounting space,
by clamping engagement between the clamping plates and the clamping grooves.

17. The manual cold laminating machine according to claim 11, wherein:
the upper housing assembly further comprises a control switch;
when the upper housing assembly is closed, it is in a default locked state that limits rotational movement;
upon pressing the control switch, the upper housing assembly switches from the default locked state to an unlocked state; and
in the unlocked state, the upper housing assembly is rotatable to switch from a closed state to an open state.

18. The manual cold laminating machine according to claim 17, wherein:
the upper housing assembly further comprises:
a latch limiting shaft,
a first latch locking plate, and
a second latch locking plate;
the first sidewall housing is provided with a first locking boss;
the second sidewall housing is provided with a second locking boss;
the control switch is provided with a latch limiting hole;
the first latch locking plate is provided with:
a first latch mounting hole, and
a first locking hook;
the second latch locking plate is provided with:
a second latch mounting hole, and
a second locking hook;
the latch limiting shaft comprises:
a control shaft segment disposed at a middle portion, and
a first mounting shaft segment and a second mounting shaft segment disposed at opposite ends;
when the upper housing assembly is closed:
the first locking hook engages with the first locking boss; and
the second locking hook engages with the second locking boss,
thereby maintaining the upper housing assembly in the default locked state;
the control shaft segment cooperates with the latch limiting hole,
such that a pressing operation on the control switch drives rotational movement of the latch limiting shaft;
the first mounting shaft segment engages with the first latch mounting hole,
the second mounting shaft segment engages with the second latch mounting hole,
such that the rotational movement of the latch limiting shaft drives rotational movements of:
the first latch locking plate, and
the second latch locking plate,
thereby switching the upper housing assembly from the default locked state to the unlocked state.

19. The manual cold laminating machine according to claim 18, wherein:
the upper housing assembly further comprises:
a first sliding abutment portion, and
a second sliding abutment portion;
the first latch locking plate is further provided with a first elastic preload portion;
the second latch locking plate is further provided with a second elastic preload portion;
a terminal end of the first elastic preload portion abuts against the first sliding abutment portion;
a terminal end of the second elastic preload portion abuts against the second sliding abutment portion;
when the upper housing assembly is closed:
the first locking hook engages with the first locking boss upon the elastic force generated by the first elastic preload portion; and
the second locking hook engages with the second locking boss upon the elastic force generated by the second elastic preload portion,
thereby maintaining the upper housing assembly in the default locked state.

20. The manual cold laminating machine according to claim 1, wherein the control handle is configured to be foldable.
